(19) United States
(12) Patent Application Publication
(10) Pub. No.: US 2014/0098292 A1
(43) Pub. Date: Apr. 10, 2014

(54) DISPLAY SYSTEM AND COMMUNICATION METHOD

(71) Applicant: WISTRON CORP., New Taipei City (TW)

(72) Inventors: Wei-Jei Chiu, New Taipei City (TW); Hsi-chun Hsiao, New Taipei City (TW); Chia-Te Chou, New Taipei City (TW)

(73) Assignee: WISTRON CORP., New Taipei City (TW)

(21) Appl. No.: 14/043,645

(22) Filed: Oct. 1, 2013

(30) Foreign Application Priority Data
Oct. 5, 2012 (TW) 101136802

(51) Int. Cl. H04N 7/025; G06K 9/00

(52) U.S. Cl. CPC H04N 7/0255; G06K 9/00523
USPC 348/552

(57) ABSTRACT

The present invention discloses a display system. The display system includes a display device, an image recognition device and a communication device. The display device is arranged to display a plurality of frames of a video stream. The image recognition device is arranged to compare the current frame with the previous frame displayed by the display device to define at least one stationary block and determine whether the stationary block has a phone number or an Internet address, wherein the current frame is the frame displayed by the display device currently, and the current frame is displayed next to the previous frame. The communication device is arranged to make a phone call to the phone number or connect to the web address via the Internet.

### CROSS REFERENCE TO RELATED APPLICATIONS

This Application claims priority of Taiwan Patent Application No. 101136802, filed on Oct. 5, 2012, the entirety of which is incorporated by reference herein.

### BACKGROUND OF THE INVENTION

1. Field of the Invention

The present invention relates to a display system, and in particular to a display system which can automatically detect phone numbers and network addresses.

2. Description of the Related Art

Recently, the functionality of electronic products has been getting increasingly powerful, and the difference between such products is getting smaller. For example, the most recent digital televisions are not only capable of displaying television shows, but also capable of other functions such as connecting to the Internet for receiving e-mail or doing electronic banking, etc.

However, using the electronic devices to enhance the lives of users is the common goal of engineers.

### BRIEF SUMMARY OF THE INVENTION

A detailed description is given in the following embodiments with reference to the accompanying drawings.

The present invention discloses a display system. The display system includes a display device, an image recognition device, and a communication device. The display device is arranged to display a plurality of frames of a video stream. The image recognition device is arranged to compare a current frame with the previous frame displayed by the display device to define at least one stationary block and determine whether the stationary block includes a phone number or an Internet address, wherein the current frame is the frame displayed by the display device currently, and the current frame is displayed next to the previous frame. The communication device is arranged to make a phone call to the phone number or connect to the web address via the Internet.

Additionally, the present invention further discloses a communication method applied to a display system, wherein the display system is arranged to display a plurality of frames of a video stream. The communication method includes: comparing a current frame with the previous frame displayed by the display device to define at least one stationary block, wherein the current frame is the frame displayed by the display device currently, and the current frame is displayed next to the previous frame; determining whether the stationary block has a phone number or an Internet address; and making a phone call to the phone number or connecting to the web address via the Internet.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of a display system of the present invention;

FIG. 2 is a schematic diagram illustrating another embodiment of a display system of the present invention;

FIG. 3 is a flowchart of a communication method according to an embodiment of the present invention;

FIG. 4A-4B are a flowchart of a communication method according to another embodiment of the present invention.

FIG. 5A-5B are a flowchart of a communication method according to another embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

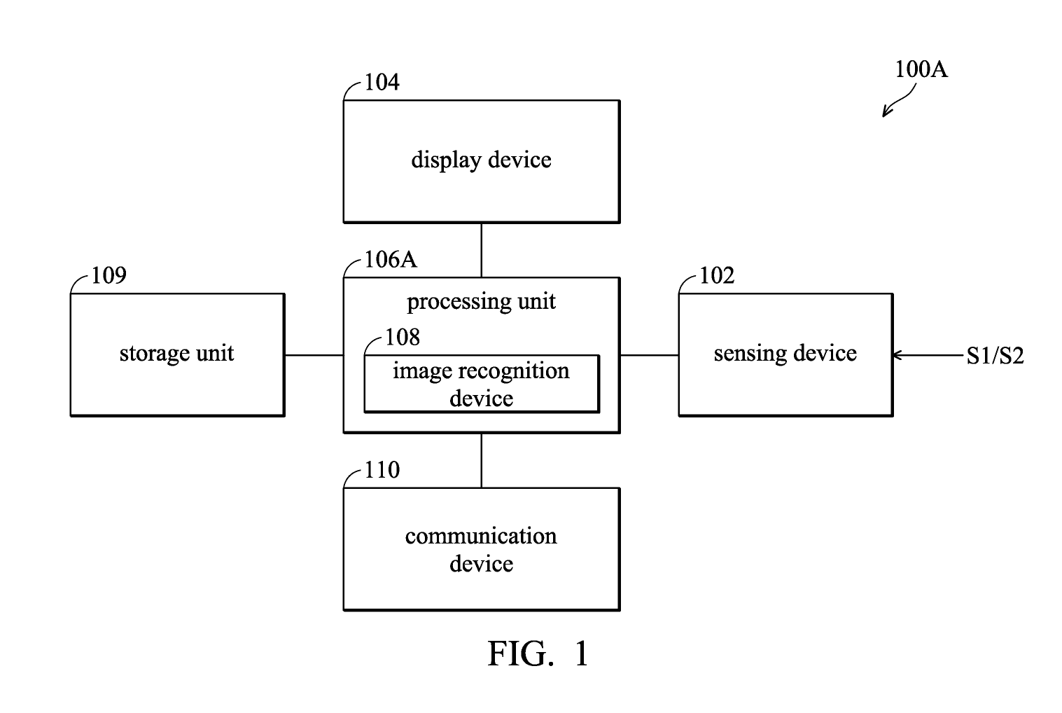

FIG. 1 is a schematic diagram illustrating an embodiment of a display system of the present invention. The display system 100A includes a sensing device 102, a display device 104, a processing unit 106A, an image recognition device 108, a storage unit 109, and a communication device 110. The display system 100A may be practiced with other computer system configurations, including hand-held devices, multiprocessor-based, microprocessor-based or programmable consumer electronics, network PCs, minicomputers, mainframe computers, and the like.

The sensing device 102 is arranged to receive a first command S1 and/or a second command S2, and transmit the first command S1 and/or the second command S2 to the processing unit 106A. It should be noted that the sensing device 102 may be arranged to detect gestures, infrared ray signals, or sound signals. Namely, the first command S1 and the second command S2 can be a gesture, an infrared ray signal, or a sound signal, but it is not limited thereto.

The display device 104 is arranged to sequentially display a plurality of frames of a video stream. It should be noted that the video stream can be an analog TV signal, a digital TV signal, or other video signals. For example, when the display system 100A is an analog TV signal, the display device 104 can be arranged to sequentially display a plurality of frames of the video stream of a shopping channel.

The display device 104 is arranged to sequentially display a plurality of frames of a video stream. It should be noted that the video stream can be an analog TV signal, a digital TV signal, or other video signals. For example, when the display system 100A is an analog TV, the display device 104 can be arranged to sequentially display a plurality of frames of the video stream of a shopping channel.

The processing unit 106A is arranged to receive the first command S1 and/or the second command S2 from the sensing device 102. Furthermore, the processing unit 106A is also arranged to enable the image recognition device 108 and the communication device 110 according to the first command S1 and/or the second command S2, respectively. It should be noted that the processing unit 106A may include a central-processing unit (CPU) or a plurality of processing units related to a parallel processing environment, but it is not limited thereto.

The processing unit 106A further includes an image recognition device 108. The image recognition device 108 is arranged to compare a current frame displayed by the display device 104 and the previous frame displayed by the display device 104 to define at least one stationary block of the current frame and the previous frame. Furthermore, the image recognition device 108 is also arranged to determine whether the stationary block has a phone number or an Internet address, wherein the image recognition device 108 is arranged to define the pixels that do not change in the current frame and the previous frame as a stationary block. Moreover, the current frame is the frame displayed by the display device 104 currently, and the current frame is displayed right next to the previous frame. Namely, the current frame is the frame that the display device 104 is displaying right now, and the previous frame is the frame that the display device 104 just played. It should be noted that, in one of the embodiments of the present invention, the image recognition device 108 starts to compare the current frame with the previous frame according to the first command S1. In another embodiment of the present invention, the image recognition device 108 is arranged to automatically compare the current frame with the previous frame every time a predetermined period has elapsed, but it is not limited thereto.

Moreover, the image recognition device 108 is further arranged to determine whether the stationary block has a character string, and determine whether the character string meets a first predetermined condition or a second predetermined condition, wherein the character string is a phone number when the character string meets the first predetermined condition, and the character string is an Internet address when the character string meets the second predetermined condition. For example, the image recognition device 108 is arranged to execute image recognition on the stationary block, and determine whether the stationary block has Arabic numerals, English letters, and punctuation marks. When the stationary block has Arabic numerals, English letters, and/or punctuation marks, the image recognition device 108 obtains a character string according to the position of the Arabic numerals, English letters, and/or punctuation marks. For example, when the Arabic numerals, English letters, and/or punctuation marks on the stationary block are arranged in a row or column, the image recognition device 108 obtains a character string according to the Arabic numerals, English letters, and/or punctuation marks. Next, the image recognition device 108 determines whether the character string meets a first predetermined condition or a second predetermined condition, wherein the first predetermined condition is the specification of phone numbers, and the second predetermined condition is the specification of Internet addresses. For example, the first predetermined condition is that the character string is a series of Arabic numbers or that the character string includes 886, 09 or 001, etc., but it is not limited thereto. Moreover, the second predetermined condition is that the character string includes the English letters www or http, etc., but it is not limited thereto.

The storage unit 109 can include a read-only memory (ROM), a flash ROM, a random access memory (RAM) and/or a register for storing the program module and data which are used for executing by the processing unit 106A. In one of the embodiments of the present invention, the image recognition device 108 can store the character string which meets the first predetermined condition or the second predetermined condition in the storage unit 109.

The communication device 110 is arranged to make a phone call to the phone number recognized by the image recognition device 108, or connect via the Internet to the web address recognized by the image recognition device 108. It should be noted that, in one of the embodiments of the present invention, the communication device 110 makes a phone call to the phone number recognized by the image recognition device 108 or connects via the Internet to the web address recognized by the image recognition device 108 according to the second command S2. In another embodiment, the image recognition device 108 is arranged to automatically make a phone call to the phone number recognized by the image recognition device 108 or connect via the Internet to the web address recognized by the image recognition device 108 when the image recognition device 108 recognizes the phone number or the Internet address. It should be noted that, in other embodiments of the present invention, the communication device 110 can transmit the phone number and/or Internet address recognized by the image recognition device 108 to other electronic devices (not shown) apart from the display system 100A, and enable the electronic device (not shown) apart from the display system 100A to make a phone call to the phone number recognized by the image recognition device 108 or connect via the Internet to the web address recognized by the image recognition device 108.

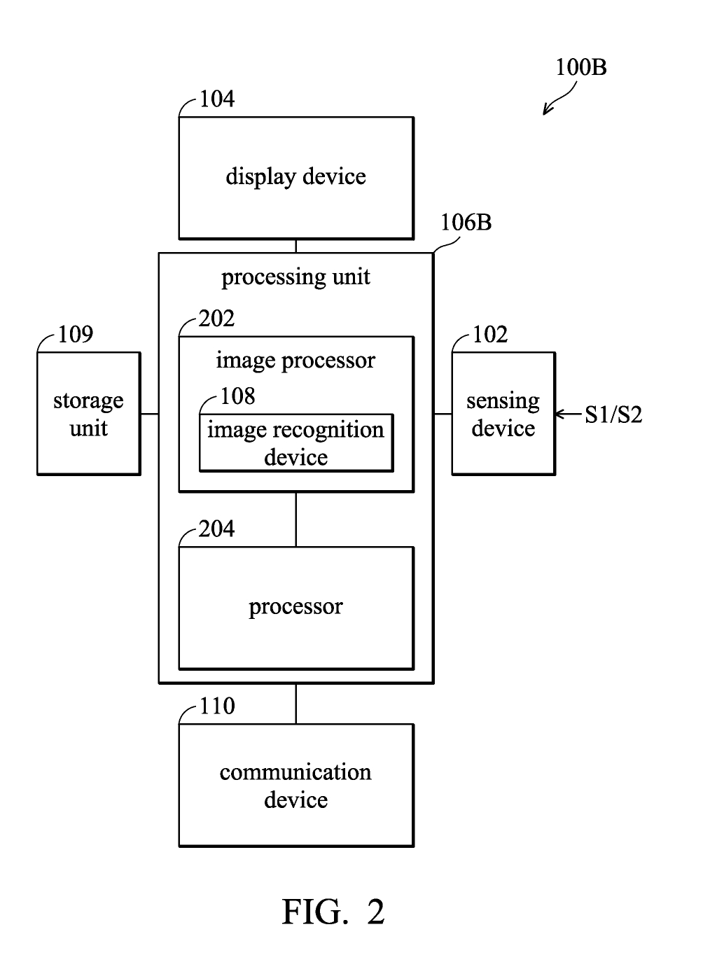

FIG. 2 is a schematic diagram illustrating another embodiment of a display system of the present invention. The display system 100B includes a sensing device 102, a display device 104, a processing unit 106B, an image recognition device 108, a storage unit 109, and a communication device 110. The display system 100B may be practiced with other computer system configurations, including hand-held devices, multiprocessor-based, microprocessor-based or programmable consumer electronics, network PCs, minicomputers, mainframe computers, and the like. Moreover, the display system 100B is similar to the display system 100A of FIG. 1 except for the processing unit 106B. The processing unit 106B further includes an image processor 202 and a processor 204. The image processor 202 is arranged to process the video stream, wherein the image processor 202 further includes an image recognition device 108. The processor 204 is arranged to receive the first command S1 and the second command S2, and enable the image recognition device 108 and the communication device 110 according to the first command S1 and the second command S2, respectively. It should be noted that reference may be made to FIG. 1 for detailed descriptions of the sensing device 102, the display device 104, the image recognition device 108, the storage unit 109, and the communication device 110.

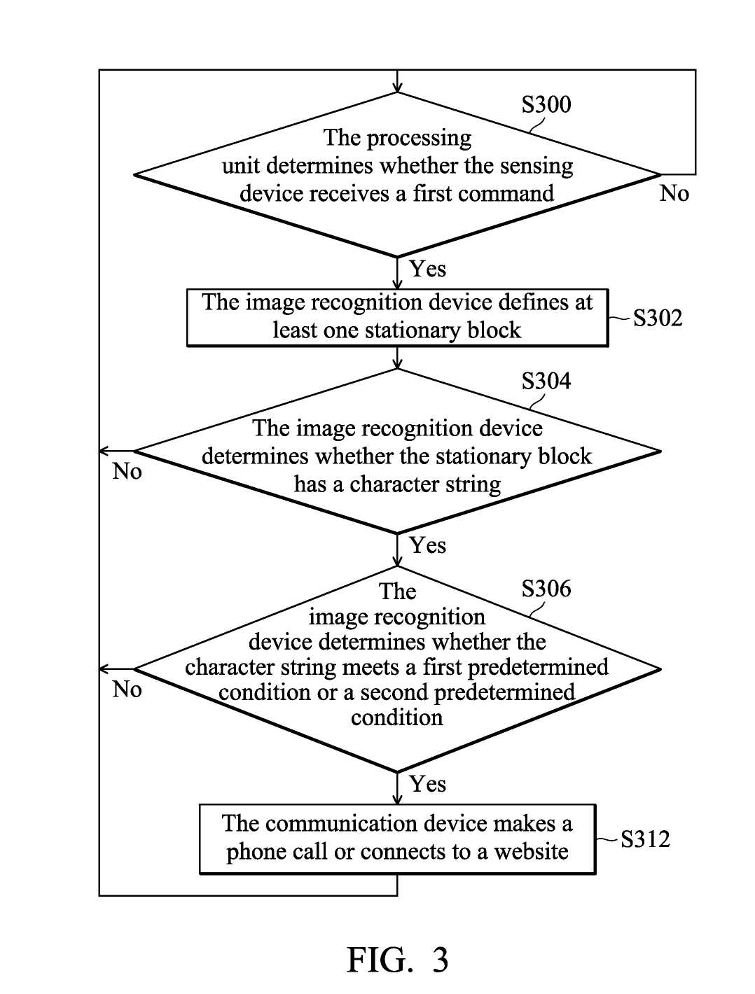

FIG. 3 is a flowchart of a communication method according to an embodiment of the present invention. The communication method is applied to the display system 100A of FIG. 1 and the display system 100B of FIG. 2, wherein the display system 100A and the display system 100B is arranged to display a plurality of frames of a video stream in sequence. The process starts at step S300.

In step S300, the processing unit 106A or the processing unit 106B is arranged to determine whether the sensing device 102 receives a first command S1. When the sensing device 102 receives the first command S1, the process goes to step S302, otherwise, the processing unit 106A or the processing unit 106B continues to determine whether the sensing device 102 receives the first command S1.

In step S302, the image recognition device 108 is arranged to compare a current frame with the previous frame displayed by the display device 104 to define at least one stationary block, wherein the current frame is the frame displayed by the display device 104 currently, and the current frame is displayed right next to the previous frame. It should be noted that the image recognition device 108 is arranged to define the pixels that do not change in the current frame from the previous frame as the stationary block. Next, the image recognition device 108 is arranged to determine whether the stationary block has a phone number or an Internet address in step S304 and step S306.

In step S304, the image recognition device 108 is arranged to determine whether the stationary block has a character string. For example, the image recognition device 108 is arranged to execute image recognition on the stationary block, and determine whether the stationary block has Arabic numerals, English letters, and punctuation marks. When the stationary block has Arabic numerals, English letters, and/or punctuation marks, the image recognition device 108 obtains a character string according to the position of the Arabic numerals, English letters, and/or punctuation marks. For example, when the Arabic numerals, English letters, and/or punctuation marks on the stationary block are arranged in a row or column, the image recognition device 108 obtains a character string according to the Arabic numerals, English letters, and/or punctuation marks. When the image recognition device 108 determines that the stationary block has a character string, the process goes to step S306, otherwise, the process goes back to step S300, and the processing unit 106A or the processing unit 106B continues to determine whether the sensing device 102 receives a first command S1.

In step S306, the image recognition device 108 is arranged to determine whether the character string meets a first predetermined condition or a second predetermined condition, wherein the character string is a phone number when the character string meets the first predetermined condition, and the character string is an Internet address when the character string meets the second predetermined condition. It should be noted that the first predetermined condition is the specification of phone numbers, and the second predetermined condition is the specification of Internet addresses. For example, the first predetermined condition is that the character string is a series of Arabic numbers or that the character string includes 886, 09 or 001, etc., but it is not limited thereto. Moreover, the second predetermined condition is that the character string includes the English letters www or http, etc., but it is not limited thereto. When the image recognition device 108 determines that the character string meets the first predetermined condition or the second predetermined condition, the process goes to step S312, otherwise, the process goes back to step S300, and the processing unit 106A or the processing unit 106B continues to determine whether the sensing device 102 receives a first command S1.

In step S312, the communication device 110 is arranged to make a phone call to the phone number recognized by the image recognition device 108, or connect via the Internet to the web address recognized by the image recognition device 108. Next, the process goes back to step S300, the processing unit 106A or the processing unit 106B continues to determine whether the sensing device 102 receives a first command S1.

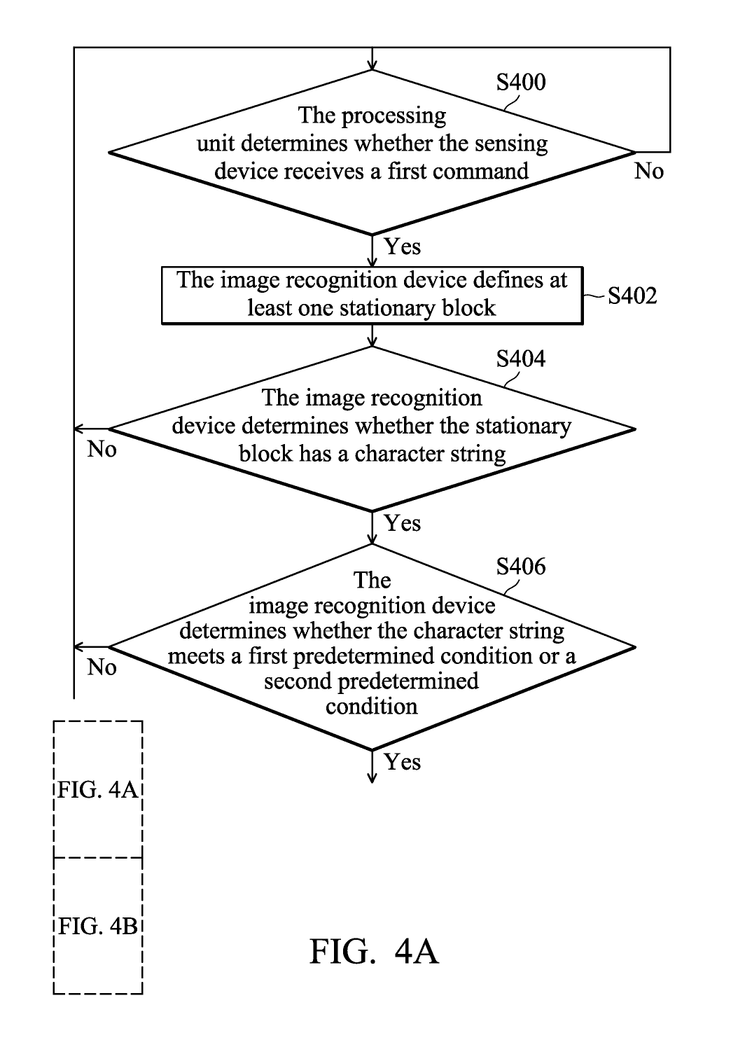

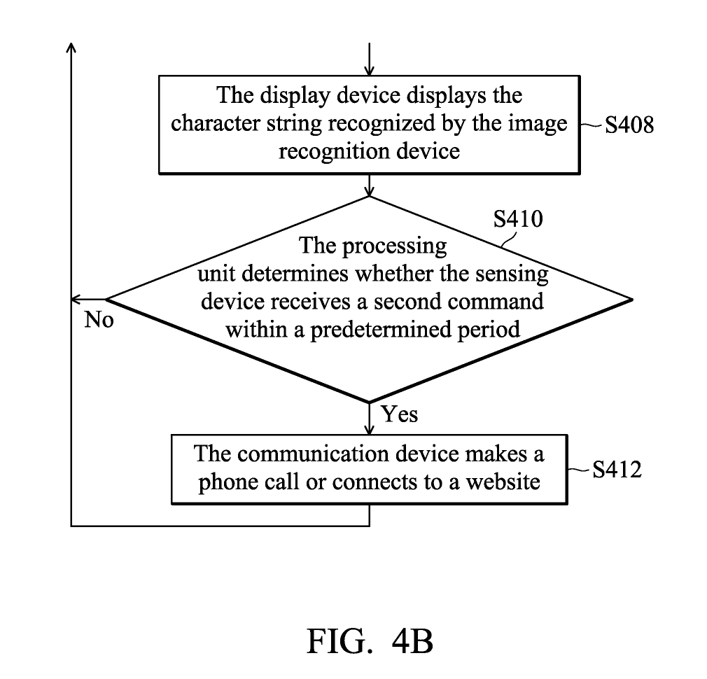

FIG. 4A-4B are a flowchart of a communication method according to another embodiment of the present invention. The communication method is applied to the display system 100A of FIG. and the display system 100B of FIG. 2, wherein the display system 100A and the display system 100B is arranged to display a plurality of frames of a video stream in sequence. The process starts at step S400. It should be noted that steps S400-S406 and S412 of FIG. 4A-4B are similar to steps S300-S306 and S312 of FIG. 3. Reference may be made to FIG. 3 for detailed descriptions of steps S400-S406 and S412.

In step S406, the image recognition device 108 is arranged to determine whether the character string meets a first predetermined condition or a second predetermined condition, wherein the image recognition device 108 determines that the character string is a phone number when the character string meets the first predetermined condition, and the image recognition device 108 determines that the character string is an Internet address when the character string meets the second predetermined condition. It should be noted that the first predetermined condition is the specification of phone numbers, and the second predetermined condition is the specification of Internet addresses. For example, the first predetermined condition is that the character string is a series of Arabic numbers or that the character string includes 886, 09 or 001, etc., but it is not limited thereto. Moreover, the second predetermined condition is that the character string includes the English letters www or http, etc., but it is not limited thereto. When the image recognition device 108 determines that the character string meets the first predetermined condition or the second predetermined condition, the process goes to step S408. Otherwise, the process goes to step S400, and the processing unit 106A or the processing unit 106B continues to determine whether the sensing device 102 receives a first command S1.

In step S408, the display device 104 is arranged to display the character string recognized by the image recognition device 108.

Next, in step S410, the processing unit 106A or the processing unit 106B is arranged to determine whether the sensing device 102 receives a second command S2 within a predetermined period. When the sensing device 102 receives the second command S2 within the predetermined period, the process goes to step S412, otherwise the process goes back to step S400, and the processing unit 106A or the processing unit 106B continues to determine whether the sensing device 102 receives a first command S1.

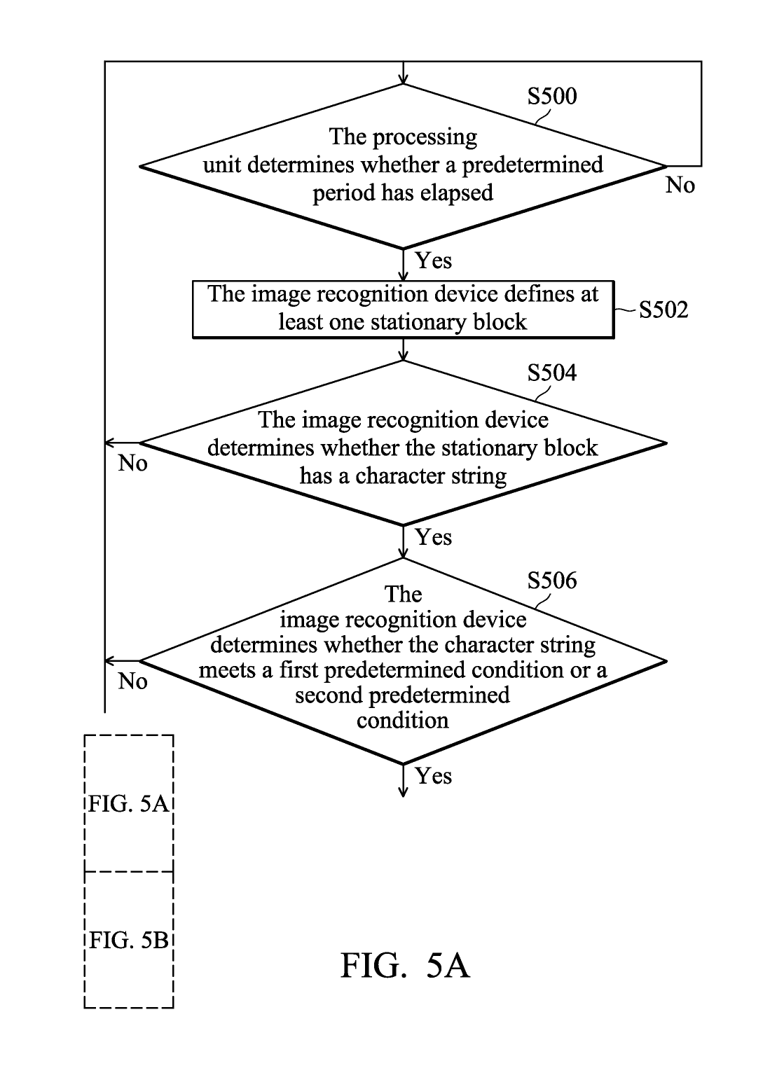

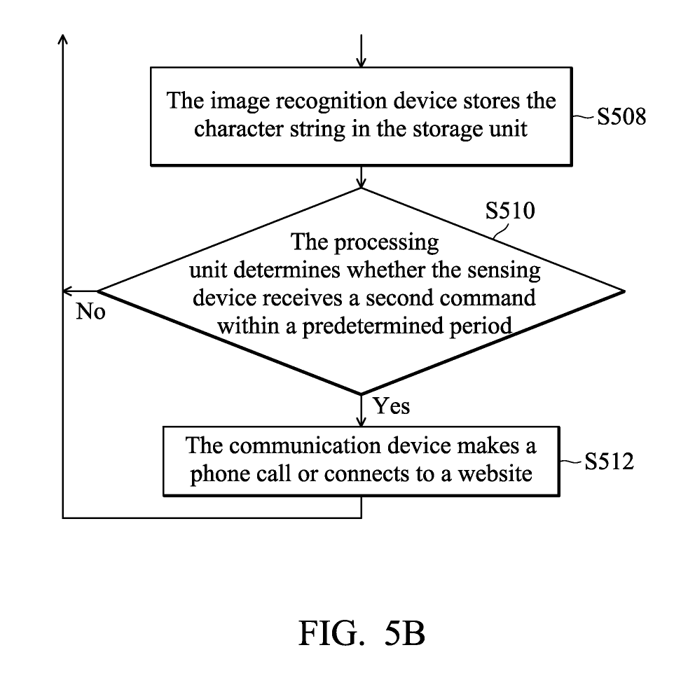

FIG. 5A-5B are a flowchart of a communication method according to another embodiment of the present invention. The communication method is applied to the display system 100A of FIG. and the display system 100B of FIG. 2, wherein the display system 100A and the display system 100B is arranged to display a plurality of frames of a video stream in sequence. The process starts at step S500.

In step S500, the processing unit 106A, the processing unit 106B, or the image recognition device 108 is arranged to determine whether a predetermined period has elapsed. When the processing unit 106A, the processing unit 106B, or the image recognition device 108 determines that the predetermined period has elapsed, the process goes to step S502, otherwise, the processing unit 106A, the processing unit 106B, or the image recognition device 108 continues to determine whether the predetermined period has elapsed.

In step S502, the image recognition device 108 is arranged to compare a current frame with the previous frame displayed by the display device 104 to define at least one stationary block, wherein the current frame is the frame displayed by the display device 104 currently, and the current frame is displayed right next to the previous frame. It should be noted that the image recognition device 108 is arranged to define the pixels that do not change in the current frame and the previous frame as the stationary block. Next, the image recognition device 108 is arranged to determine whether the stationary block has a phone number or an Internet address in step S504 and step S506.

In step S504, the image recognition device 108 is arranged to determine whether the stationary block has a character string. For example, the image recognition device 108 is arranged to execute image recognition on the stationary block, and determine whether the stationary block has Arabic numerals, English letters, and punctuation marks. When the stationary block has Arabic numerals, English letters, and/or punctuation marks, the image recognition device 108 obtains a character string according to the position of the Arabic numerals, English letters, and/or punctuation marks. For example, when the Arabic numerals, English letters, and/or punctuation marks on the stationary block are arranged in a row or column, the image recognition device 108 obtains a character string according to the Arabic numerals, English letters, and/or punctuation marks. When the image recognition device 108 determines that the stationary block has a character string, the process goes to step S506, otherwise, the process goes back to step S500.

In step S506, the image recognition device 108 is arranged to determine whether the character string meets a first predetermined condition or a second predetermined condition, wherein the character string is a phone number when the character string meets the first predetermined condition, and the character string is an Internet address when the character string meets the second predetermined condition. It should be noted that the first predetermined condition is the specification of phone numbers, and the second predetermined condition is the specification of Internet addresses. For example, the first predetermined condition is that the character string is a series of Arabic numbers or that the character string includes 886, 09 or 001, etc., but it is not limited thereto. Moreover, the second predetermined condition is that the character string includes the English letters www or http, etc., but it is not limited thereto. When the image recognition device 108 determines that the character string meets the first predetermined condition or the second predetermined condition, the process goes to step S508, otherwise, the process goes back to step S500, and the processing unit 106A or the processing unit 106B continues to determine whether the predetermined period has elapsed.

In step S508, the image recognition device 108 stores the character string which meets the first predetermined condition or the second predetermined condition in the storage unit 109.

Next, in step S510, the processing unit 106A or the processing unit 106B is arranged to determine whether the sensing device 102 receives a second command S2 within a predetermined period. When the sensing device 102 receives the second command S2 within the predetermined period, the process goes to step S512, otherwise, the process goes back to step S500.

In step S512, the communication device 110 is arranged to make a phone call to the phone number recognized by the image recognition device 108, or connect via the Internet to the web address recognized by the image recognition device 108. Next, the process goes back to step S500, the processing unit 106A, the processing unit 106B or the image recognition device 108 continues to determine whether the predetermined period has elapsed.

The display system 100A, the display system 100B and the communication method of the present invention can determine whether the image displayed by the display device 104 has phone numbers or Internet addresses. Moreover, the display system 100A, the display system 100B and the communication method of the present invention can also make phone calls to the displayed phone number or connect via the Internet to the displayed web address.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display system, comprising:
a display device, said display device sequentially displays a video stream, said video stream comprising a current frame and a previous frame;
an image recognition device, said image recognition device compare the current frame with the previous frame to define at least one stationary block and determine whether said stationary block has a communication information; and
a communication device, said communication device make contact to said communication information.

2. The display system as claimed in claim 1, wherein said image recognition device determine whether said communication information meets a first predetermined condition or a second predetermined condition.

3. The display system as claimed in claim 2, wherein said communication information is the phone number when the communication information meets the first predetermined condition, and said communication information is the Internet address when said communication information meets the second predetermined condition.

4. The display system as claimed in claim 1, further comprising a sensing device to receive a first command, wherein said image recognition device compare said current frame with said previous frame according to said first command.

5. The display system as claimed in claim 4, wherein said sensing device receive a second command, and said communication device make a phone call to said phone number or connect to said Internet address, according to said second command.

6. The display system as claimed in claim 5, wherein said first command and said second command comprise at least one of gestures, infrared ray signals, or sound signals.
